(19) United States
(12) Patent Application Publication
(10) Pub. No.: US 2024/0276500 A1
(43) Pub. Date: Aug. 15, 2024

(54) COMMUNICATING A NUMBER OF RESOURCE BLOCKS (RBS) PARAMETER AND A MAPPING TYPES PARAMETER FOR PHYSICAL UPLINK CONTROL CHANNEL (PUCCH) CONFIGURATION

(71) Applicant: Lenovo (Singapore) Pte. Ltd., New Tech Park (SG)

(72) Inventors: Ali Ramadan Ali, Kraiburg am Inn (DE); Ankit Bhamri, Rödermark (DE); Sher Ali Cheema, Ilmenau (DE); Alexander Johann Maria Golitschek Edler von Elbwart, Darmstadt (DE); Karthikeyan Ganesan, Kronberg im Taunus (DE)

(21) Appl. No.: 18/560,231

(22) PCT Filed: May 10, 2022
(86) PCT No.: PCT/IB2022/054349

§ 371 Date: Nov. 10, 2023

Related U.S. Application Data
(60) Provisional application No. 63/186,404, filed on May 10, 2021.

(51) Int. Cl. H04W 72/21; H04B 17/318; H04L 5/00

(52) U.S. Cl. CPC H04W 72/21; H04B 17/328; H04L 5/0094

(57) ABSTRACT

Apparatuses and methods for communicating a number of resource blocks (RBs) 502 parameter and a mapping types parameter for physical uplink control channel (PUCCH) configuration. An apparatus 102 determines connection status. In response to determining that the connection status is not connected. the apparatus 102 selects one of first parameters indicating a number of RBs 502 and one of second parameters indicating mapping types included in a previously received configuration for the transmission of PUCCH having a predefined table with the first and second parameters. In response to determining that connection status is connected. the apparatus 102 receives a dedicated PUCCH resource configuration (radio resource control (RRC) message) having a third parameter indicating a number of RBs 502 and a fourth parameter indicating a mapping type. The apparatus 102 generates a PUCCH transmission responsive to the selected first and second parameters or the received third and fourth parameters.

### CROSS-REFERENCE TO RELATED APPLICATIONS

This application claims priority to United States Patent Application Ser. No. 63/186,404 entitled “APPARATUSES, METHODS, AND SYSTEMS FOR RESOURCE INDICATION FOR MULTI-RB PUCCH FORMATS 0, 1, AND/OR 4” and filed on May 10, 2021 for Ali Ramadan Ali, which is incorporated herein by reference in its entirety.

### FIELD

The subject matter disclosed herein relates generally to wireless communications and more particularly relates to communicating a number of resource blocks (RBs) parameter and a mapping types parameter for physical uplink control channel (PUCCH) configuration.

### BACKGROUND

In certain wireless communications networks, two mapping options for PUCCH configuration have been discussed. However, no specific agreements on the supported mapping method or on the indication/signaling procedure are in existence.

### BRIEF SUMMARY

Methods for communicating a number of RBs parameter and a mapping types parameter for PUCCH configuration are disclosed. Apparatuses and systems also perform the functions of the methods. One embodiment of a method includes determining connection status of the UE. In some embodiments, in response to determining that the connection status is not connected, one of first parameters indicating a number of RBs and one of second parameters indicating mapping types included in a previously received configuration for the transmission of PUCCH having a predefined table with the first and second parameters are selected. In some embodiments, in response to determining that connection status is connected, a dedicated PUCCH resource configuration (radio resource control (RRC) message) having a third parameter indicating a number of RBs and a fourth parameter indicating a mapping type is received and a PUCCH transmission is generated responsive to the selected first and second parameters or the received third and fourth parameters.

One apparatus for communicating a number of RBs parameter and a mapping types parameter for PUCCH configuration includes user equipment. In some embodiments, the apparatus includes a receiver, a transmitter, a processor, and a memory that stores code executable by the processor. The code causes the processor to determine connection status of the apparatus: in response to determining that the connection status is not connected, select one of first parameters indicating a number of RBs and one of second parameters indicating mapping types included in a previously received configuration for the transmission of PUCCH having a predefined table with the first and second parameters: in response to determining that connection status is connected, receive a dedicated PUCCH resource configuration (RRC message) having a third parameter indicating a number of RBs and a fourth parameter indicating a mapping type: and generate a PUCCH transmission responsive to the selected first and second parameters or the received third and fourth parameters.

Another apparatus for communicating a number of RBs parameter and a mapping types parameter for PUCCH configuration for aiding in the generation of PUCCH transmissions includes a network unit. In some embodiments, the network unit includes a receiver, a transmitter, a processor, and a memory that stores code executable by the processor. The code causes the processor to generate an index configured to identify a first parameter indicating a number of RBs and a second parameter indicating mapping types included in a previously determined configuration for the transmission of PUCCH having a predefined table with the first and second parameters, transmit via the transmitter the index to a remote unit determined to in an idle mode, receive via the receiver a selection of the first and second parameters from the remote unit, perform an acknowledgement of the received selection, and transmit via the transmitter the acknowledgement to the remote unit.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for communicating a number of RBs parameter and a mapping types parameter for resource indication of PUCCH:

FIG. 2 is a schematic block diagram illustrating one embodiment of an apparatus that may be used for communicating a number of RBs parameter and a mapping types parameter for resource indication of PUCCH:

FIG. 3 is a schematic block diagram illustrating one embodiment of an apparatus that may be used for communicating a number of RBs parameter and a mapping types parameter for resource indication of PUCCH:

FIG. 4 is a schematic block diagram illustrating one embodiment of a system for communicating a number of RBs parameter and a mapping types parameter for resource indication of PUCCH:

FIG. 5 is a schematic block diagram illustrating one embodiment of a system for communicating a number of RBs parameter and a mapping types parameter for resource indication of PUCCH: and

FIG. 6 is a flowchart diagram illustrating one embodiment of a method for communicating a number of RBs parameter and a mapping types parameter for resource indication of PUCCH.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising.” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments.

One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative embodiments, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

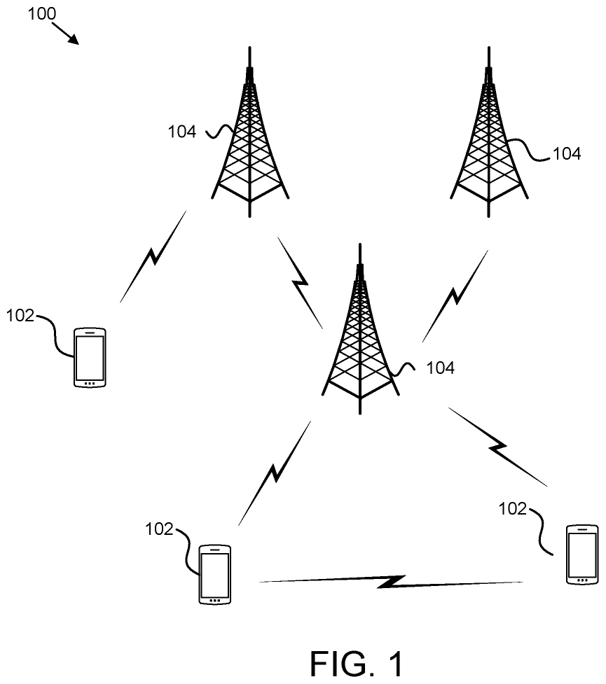

FIG. 1 depicts an embodiment of a wireless communication system 100 for communicating a number of RBs parameter and a mapping types parameter for resource indication of PUCCH. In one embodiment, the wireless communication system 100 includes remote units (apparatus, user equipment) 102 and network units (gNB) 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one embodiment, the wireless communication system 100 is compliant with the 3GPP protocol, wherein the network unit 104 transmits using an orthogonal frequency division multiplexing (OFDM) modulation scheme on the DL and the remote units 102 transmit on the upload (UL) using a single-carrier frequency division multiple access (SC-FDMA) scheme or an OFDM scheme. More generally, however, the wireless communication system 100 may implement some other open or proprietary communication protocol, for example, worldwide interoperability for microwave access (WiMAX), among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit download (DL) communication signals to serve the remote units 102 in the time, frequency, and/or spatial domain.

In various embodiment, a remote unit 102 determines its connection status, then selects or receives a number of RBs and a mapping types based on the determined connection status. The remote unit 102 generates PUCCH transmissions based on the selected number of

RBs and a mapping types.

In certain embodiments, the network unit 104 may generate an index configured to identify a first parameter indicating a number of RBs and a second parameter indicating mapping types included in a previously determined configuration for the transmission of PUCCH having a predefined table with the first and second parameters and transmit the generated index to a remote unit determined to in an idle mode. In some embodiments, the network unit 104 may receive a selection of the first and second parameters from the remote unit, perform an acknowledgement of the received selection, and transmit the acknowledgement to the remote unit 102.

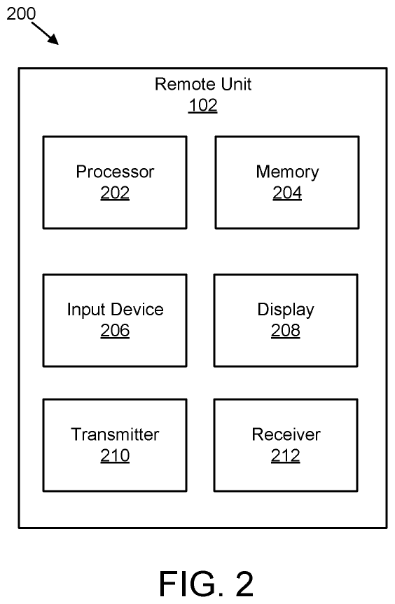

FIG. 2 depicts one embodiment of an apparatus 200 that may be used for

communicating a number of RBs parameter and a mapping types parameter for PUCCH configuration. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, an LCD display, an LED display, an OLED display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In one embodiment, the remote unit 102 determines connection status of the remote unit 102 and in response to determining that the connection status is not connected, selects one of first parameters indicating a number of RBs and one of second parameters indicating mapping types included in a previously received configuration for the transmission of PUCCH having a predefined table with the first and second parameters. In some embodiments, in response to determining that connection status is connected, the remote unit 102 receives a dedicated PUCCH resource configuration (radio resource control (RRC) message) having a third parameter indicating a number of RBs and a fourth parameter indicating a mapping type and generates a physical uplink control channel (PUCCH) transmission responsive to the selected first and second parameters or the received third and fourth parameters.

The transmitter 210 is used to provide UL communication signals to the network unit 104 and the receiver 212 is used to receive DL communication signals from the network unit 104, as described herein. Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

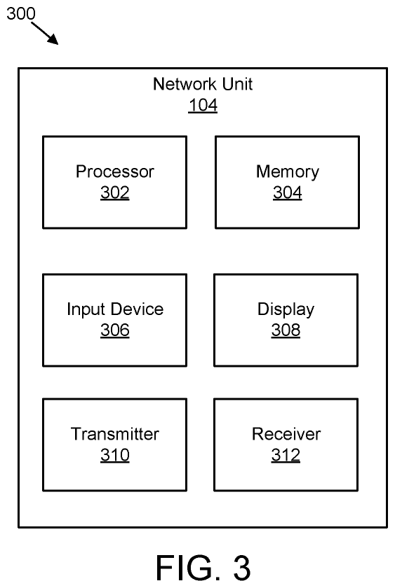

FIG. 3 depicts one embodiment of an apparatus 300 that may be used for communicating a number of RBs parameter and a mapping types parameter for PUCCH configuration. n. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

The network unit includes a receiver, a transmitter, a processor. and a memory that stores code executable by the processor. The code causes the processor to generate an index configured to identify a first parameter indicating a number of resource blocks (RBs) and a second parameter indicating mapping types included in a previously determined configuration for the transmission of physical uplink control channel (PUCCH) having a predefined table with the first and second parameters, transmitting the index to a remote unit determined to in an idle mode, receive a selection of the first and second parameters from the remote unit, perform an acknowledgement of the received selection, and transmit the acknowledgement to the remote unit.

Although only one transmitter 310 and one receiver 312 are illustrated, the network unit 104 may have any suitable number of transmitters 310 and receivers 312. The transmitter 310 and the receiver 312 may be any suitable type of transmitters and receivers. In one embodiment, the transmitter 310 and the receiver 312 may be part of a transceiver.

It should be noted that one or more embodiments described herein may be combined into a single embodiment.

In some embodiments, PUCCH formats 0, 1, 4 are designed in such a way that they span only one single PRB. The one single PRB is good enough for sending a few numbers of UCI information on licensed spectrum with good peak to average power ratio (PAPR). There is no solution in the specification (PUCCH resource configuration) to handle the PSD issues of single PRB formats in case of an unlicensed spectrum.

In various embodiments, a signalling procedure is provided for indicating a number of RBs and an RB mapping type for the enhanced PUCCH format 0/1/4 or other existing or new PUCCH formats in unlicensed band under a PSD limitation. The procedure includes:
1. Indicating the number of RBs and the type of mapping before radio resource control (RRC) connection:
2. Indicating the number of RBs and the mapping type for dedicated PUCCH configuration for RRC connected UEs: and/or
3. Indicating dynamic downlink control information (DCI) indication to enable/disable/update the PUCCH RB configuration.

In various embodiments, a design of PUCCH transmission based on combining long sequence with frequency domain repetition to achieve a trade-off between multiplexing gain and coverage gain is provided.

In a first embodiment, the number of RBs and the mapping type are indicated before RRC connection. The UE is pre-configured with a plurality of PUCCH resource sets, e.g. by means of a table including the number of RBs used to enhance the coverage of PUCCH transmission that carries acknowledgement/non-acknowledgement (ACK/NACK) information of message (Msg)4/MsgB during initial access. The number of RBs is determined based on the available RBs in the initial bandwidth part (BWP) and a supported SCS as well as the number of cyclic shifts for different PUCCH resources. In one embodiment, for the UEs before receiving the dedicated PUCCH configuration, a table (Rel 16.5.0 Table 9.2.1-1 [TS 38.213]) is modified to include the number of the required RBs for different SCS values. In addition to the region regulations in terms of the PSD limitation and the SCS to be used for initial access, the number of the initial cyclic shifts impacts the required number of RBs of a PUCCH resource set. The required number of the RBs in the modified table relies also on the PRB offset, such that for high PRB offset, the number of RBs is reduced. In alternative embodiment, the UE is pre-configured with only the maximum number of RBs for different SCS {120kHz_maxNofRBs. 480kHz maxNofRBs, 960kHz_maxNofRBs}, and the UE selects the corresponding number of RBs based on the configured SCS. Another additional parameter in the modified table is the PRB mapping type which is determined based on the number of the PRBs, such that in order to avoid the increase of the PAPR, for high number of RBs, long sequence is used while for low number of RBs either long sequence or repetition is used. Table 1 shows the modified PUCCH resource sets before PUCCH resource configuration.

TABLE 1
Modified PUCCH resource sets before dedicated PUCCH resource configuration

| | | | | | | RB | |
|---|---|---|---|---|---|---|---|
| | | | | | Number | Mapping | |
| | | | | | of RBs | type | Set of |
| | | | Number | PRB | {120 kHz, | {120 kHz, | initial |
| | PUCCH | First | of | offset | 480 kHz, | 480 kHz, | CS |
| Index | format | symbol | symbols | RB_{BWP}^{offset} | 960 kHz} | 960 kHz} | indexes |
| 0 | 0 | 12 | 2 | 0 | {8, 4, 1} | {0, 1, 0} | {0, 3} |
| 1 | 0 | 12 | 2 | 0 | {10, 6, 4} | {0, 1, 1} | {0, 4, 8} |
| 2 | 0 | 12 | 2 | 3 | {8, 4, 1} | {1, 1, 0} | {0, 4, 8} |
| 3 | 1 | 10 | 4 | 0 | {8, 4, 1} | {0, 1, 0} | {0, 6} |
| 4 | 1 | 10 | 4 | 0 | {12, 8, 4} | {0, 0, 1} | {0, 3, 6, 9} |
| 5 | 1 | 10 | 4 | 2 | {10, 6, 4} | {0, 1, 1} | {0, 3, 6 ,9} |
| 6 | 1 | 10 | 4 | 4 | {8, 4, 1} | {0, 1, 0} | {0, 3, 6, 9} |
| 7 | 1 | 4 | 10 | 0 | {8, 4, 1} | {1, 1, 0} | {0, 6} |

RB mapping type 0 represents single sequence, while 1 represents repetition.

In system information block 1 (SIB1) an index for the table, which identifies number of RBs, RB mapping type etc., are signaled to the UE as part of the PUCCH-ConfigCommon.

PUCCH-ConfigCommon ::= SEQUENCE {

| | |
|---|---|
| pucch-ResourceCommon | INTEGER (0..15) OPTIONAL, -- Need R |
| pucch-GroupHopping | ENUMERATED { neither, enable, disable }, |
| hoppingId | INTEGER (0..1023) OPTIONAL, -- Need R |
| p0-nominal | INTEGER (−202..24) OPTIONAL, -- |
| | Need R |
| ... | |
| } | |

As an example, index 3 of pucch-ResourceCommon indicates to the UE, along with other PUCCH configuration elements, that 8 RBs with long sequence need to be used in case of 120 kHz, 4 RBs with repetition in case of 480 kHz, and 1 RB in case of 960k Hz.

In another embodiment, since the number of the required RBs to satisfy a certain PSD limit varies based on the power class of the UE as well as the UE antenna gain, multiple number of RBs is specified in the PUCCH resource configuration table where these different numbers correspond to different power classes of the UE and/or the potential UE antenna gain configurations.

In some embodiments, the PRB offset is also indicated as set for each of index in Table 1 and Table 2, wherein the PRB offset value to be applied can depend upon the number of RBs, RB mapping type, or some combination thereof.

In some embodiments, additional indices can also be added to the table to allow different combination of number of symbols, number of RBs, and/or RB mapping type for each of the PUCCH formats.

In some embodiments, an additional RB mapping type can be indicated, for

example, RB mapping type 2, where a combination of long sequence (covering more than 1 RB) and repetition of the long sequence can be applied. It can basically be a combination of RB mapping type 1 and RB mapping type 2.

TABLE 2
Modified PUCCH resource sets before dedicated PUCCH
resource configuration for multiple UE power classes

| | | | | | Number of RBs | | |
|---|---|---|---|---|---|---|---|
| | | | | | Power class | | |
| | | | | | cat 1 {120 kHz, | | |
| | | | | | 480 kHz, 960 kHz) | | Set of |
| | | | Number | PRB | Power class | RB | initial |
| | PUCCH | First | of | offset | cat 2 {120 kHz, | Mapping | CS |
| Index | format | symbol | symbols | RB_{BWP}^{offset} | 480 kHz, 960 kHz) | type | indexes |
| 0 | 0 | 12 | 2 | 0 | {8, 4, 1} | {0, 1, 0} | {0, 3} |
| | | | | | {10, 6, 2} | {0, 0, 1} | |
| 1 | 0 | 12 | 2 | 0 | {10, 6, 4} | {0, 1, 1} | {0, 4, 8} |
| | | | | | {12, 8, 6} | {0, 0, 0} | |
| 2 | 0 | 12 | 2 | 3 | {8, 4, 1} | {1, 1, 0} | {0, 4, 8} |
| | | | | | {10, 6, 2} | {0, 1, 1} | |
| 3 | 1 | 10 | 4 | 0 | {8, 4, 1} | {0, 1, 0} | {0, 6} |
| | | | | | {10, 6, 2} | {0, 0, 1} | |
| 4 | 1 | 10 | 4 | 0 | {12, 8, 4} | {0, 0, 1} | {0, 3, 6, 9} |
| | | | | | {16, 10, 6} | {0, 0, 0} | |
| 5 | 1 | 10 | 4 | 2 | {10, 6, 4} | {0, 1, 1} | {0, 3, 6, 9} |
| | | | | | {14, 8, 6} | {0, 0, 0} | |
| 6 | 1 | 10 | 4 | 4 | {8, 4, 1} | {0, 1, 0} | {0, 3, 6, 9} |
| | | | | | {10, 6, 2} | {0, 0, 1} | |
| 7 | 1 | 4 | 10 | 0 | {8, 4, 1} | {1, 1, 0} | {0, 6} |
| | | | | | {10, 6, 2} | {0, 0, 1} | |

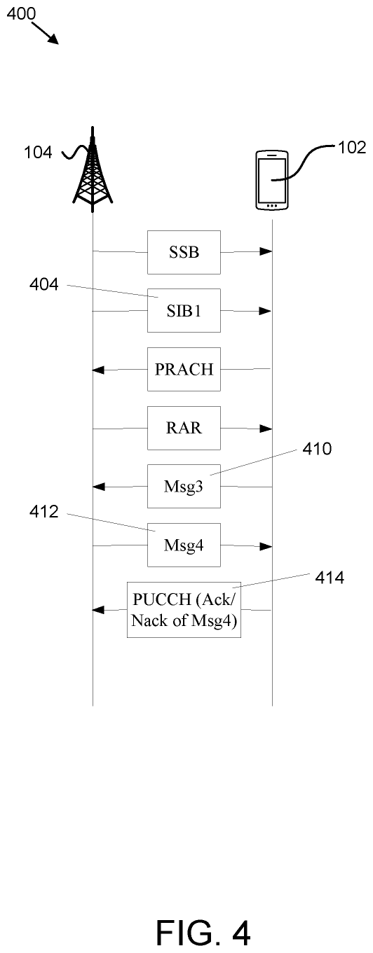

In one embodiment, as shown in FIG. 4, within the SIBI message 404, the gNB 104 includes an index for finding a particular location is the previously defined PUCCH resource configuration table. The UE 102, in the situation where the UE 102 is idle, selects the parameters stored in the previously defined PUCCH resource configuration table based on the index in the SIBI message 404. The UE 102 sends this selection in Msg3 410 back to the gNB 104. At Msg4 412, the gNB 104 acknowledges back to the UE 102 the selection included 10 in Msg3 410. At a PUCCH 414, the UE 102 uses the selected resources based on an acknowledgment Msg4 412 from the gNB 104 to generate PUCCH transmissions.

In one embodiment, the UE 102 autonomously selects the number of the RBs corresponding to the power class and/or the antenna gain and reports its selection in Msg3 410. The gNB 104 may indicate the validity of the UE 102 selection in DCI of Msg4 412, e.g. by including an indicator for the number of RBs. Generally, the indication of the gNB 104 in Msg4 412 may override the selection included in Msg 3 410; in such a case, the UE 102 applies the indication in Msg4 412 for the transmission of the corresponding ACK/NACK.

In another embodiment, the UE 102 may autonomously select the number of RBs and mapping type during an attachment procedure. The UE 102 in an RRC connected mode is indicated using UE specific PUCCH resource configuration RRC message with the parameters for PUCCH configuration. The gNB 104 associates each PUCCH Resource ID with both the number of RBs and the mapping type. In one embodiment, the number of RBs and the corresponding RB mapping type can be determined based on the PSD limit for the region, the available RBs in the BWP, the configured SCS, the number of cyclic shifts for different PUCCH resource sets, as well as the number of the connected UEs in the cell.

In another embodiment, the gNB 104 configures the UE 102 with the number of RBs based on a power headroom report (PHR) and beamforming gain of UE transmission. Two values are present in the PUCCH resource configuration of PUCCH formats 0/1/4. These values are nrofPRBs which starts from a single RB up to the maximum number of the RBs and mappType with 0 and 1 values, where 0 represents long sequence for both PUCCH format 0/1 and long DFT that spans the RBs for PUCCH format 4, while 1 represents frequency domain repetition of a single RB over the configured number of RBs. Basically, the repetition factor is equal to the number of PRBs, when no explicit indication of repetition factor is indicated and the sequence/DFT length is equal to 12. In some embodiments, the repetition factor can be explicitly indicated. In one example, a longer sequence can be used for higher number of RBs while repetition can be configured for lower number of RBs.

| | |
|---|---|
| PUCCH-ResourceId ::= | INTEGER (0..maxNrofPUCCH-Resources-1) |
| PUCCH-format0 ::= | SEQUENCE { |
| nrofPRBs | INTEGER (1.. maxNofRBs), |
| mappType | INTEGER (0,1), |
| initialCyclicShift | INTEGER(0..11), |
| nrofSymbols | INTEGER (1..2), |
| startingSymbolIndex | INTEGER(0..13) |
| } | |
| PUCCH-format1 ::= | SEQUENCE { |
| nrofPRBs | INTEGER (1.. maxNofRBs), |
| mappType | INTEGER (0,1), |
| initialCyclicShift | INTEGER(0..11), |
| nrofSymbols | INTEGER (4..14), |
| startingSymbolIndex | INTEGER(0..10), |
| timeDomainOCC | INTEGER(0..6) |
| } | |
| PUCCH-format4 ::= | SEQUENCE { |
| nrofPRBs | INTEGER (1.. maxNofRBs), |
| mappType | INTEGER (0,1), |
| nrofSymbols | INTEGER (4..14), |
| occ-Length | ENUMERATED {n2,n4}, |
| occ-Index | ENUMERATED {n0,n1,n2,n3}, |
| startingSymbolIndex | INTEGER(0..10) |
| } | |

In another embodiment, two fields may be inserted in the DCI to separately indicate the number of RBs and the mapping type of the corresponding PUCCH resources. This occurs for a dedicated PUCCH resource configuration that occurs when the UE 102 is determined to connected to the gNB 104. 5

In a third embodiment, indication of the combined RB mapping types is provided. The UE 102 in an RRC connected mode is indicated using UE specific PUCCH resource configuration RRC message with the required parameters for multi-RB enhanced PUCCH formats 0/1/4. The gNB 104 associates each PUCCH Resource identifier (ID) with the number of RBs and the mapping type. In addition to these two parameters, the UE 102 is indicated to 10 combine both mapping options in order to achieve a certain trade-off between the coverage gain and the UE multiplexing gain. A long sequence mapping option, for which PUCCH formats 0/1 is generated with a sequence of length equal to the number of the configured RBs, has been observed to be the better candidate for enhancing the coverage of PUCCH transmission, since it gives better maximum isotropic loss (MIL) tolerance due to its low PAPR compared with frequency domain repetition. On the other hand, frequency domain repetition of PUCCH formats 0/1/4 gives a better chance for FDM multiplexing of UEs and can achieve more multiplexing gain than long sequence options. In the scenarios where the UE 102 is located at a cell edge, the coverage of PUCCH transmission would be the bottle neck for the UE 102 to reach the gNB 104 with sufficient power. Therefore, the long sequence option or long DFT is chosen for mapping the PUCCH PRBs, while for the scenarios where large number of UEs 102 are connected to the network, a frequency domain repetition may avoid resource shortage of the cell. However, the scenarios with moderate coverage requirements and moderate multiplexing requirements may benefit from a combination of both options. The number of RBs and the combination factor which indicates the length of the sequence and the number of repetitions to be applied is signaled to the UE 102 using RRC dedicated PUCCH configuration as shown below.

| | |
|---|---|
| PUCCH-ResourceId ::= | INTEGER (0..maxNrofPUCCH-Resources-1) |
| PUCCH-format0 ::= | SEQUENCE { |
| nrofPRBs | INTEGER (1.. maxNofRBs), |
| mappType | INTEGER (0,1), |
| initialCyclicShift | INTEGER(0..11), |
| nrofSymbols | INTEGER (1..2), |
| startingSymbolIndex | INTEGER(0..13) |
| } | |
| PUCCH-format1 ::= | SEQUENCE { |
| nrofPRBs | INTEGER (1.. maxNofRBs), |
| nrofFreqRepetitions | INTEGER (1..nrofPRBs), |
| initialCyclicShift | INTEGER(0..11), |
| nrofSymbols | INTEGER (4..14), |
| startingSymbolIndex | INTEGER(0..10), |
| timeDomainOCC | INTEGER(0..6) |
| } | |
| PUCCH-format4 ::= | SEQUENCE { |
| nrofPRBs | INTEGER (1.. maxNofRBs), |
| nrofFreqRepetitions | INTEGER (1..nrofPRBs), |
| nrofSymbols | INTEGER (4..14), |
| occ-Length | ENUMERATED {n2,n4}, |
| occ-Index | ENUMERATED {n0,n1,n2,n3}, |
| startingSymbolIndex | INTEGER(0..10) |
| } | |

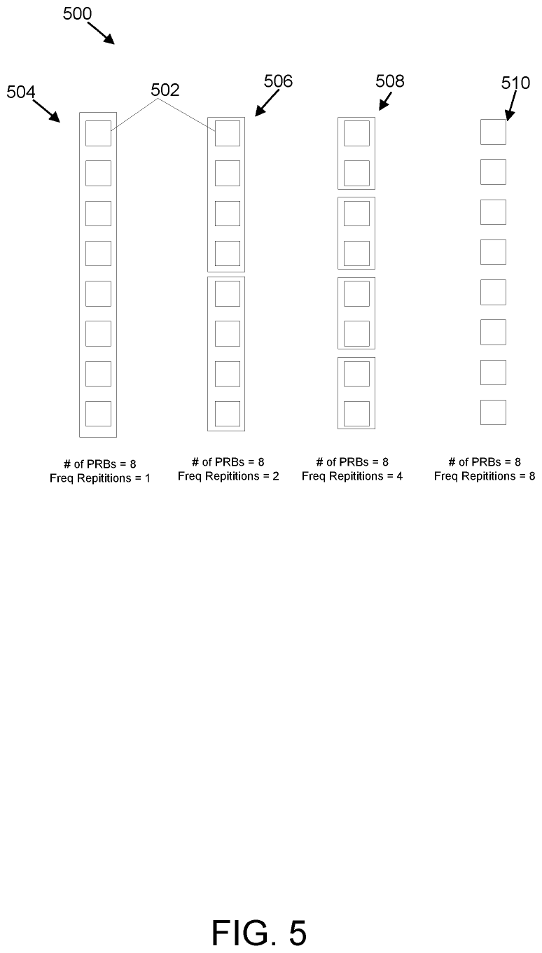

In one embodiment, the parameter nrofFreqRepetitions signaled in the dedicated PUCCH resource set configuration controls the combination options between the long sequence/long DFT and the frequency domain repetition for PUCCH resource mapping. The sequence length for generating PUCCH format 0/1 or the DFT length for generating PUCCH format 4 is determined by the UE based on SeqL=nrofPRBs/nrofFreqRepetitions as shown in FIG. 5. If the number of repetitions is equal to the number of RBs, then only repetition type is used, while if the number of repetitions is 1, only long sequence or long DFT that spans all RBs is used. In alternative embodiment, the UE is indicated with the number of the repetition and the number of RBs in each repetition, such that the number of RBs is the multiplication of both.

As shown in FIG. 5, a combination of long sequence and frequency domain repetition are presented. Two fields in the DCI are included to indicate the number of RBs and the number of repetitions of the corresponding PUCCH resources. Group 504 shows when the number of repetitions equals 1. Groups 506 shows when the number of repetitions equals 2. Groups 508 shows when the number of repetitions equals 4. Groups 510 shows when the number of repetitions equals the number of RBs—8. The UE 102 may be dynamically indicated in the DCI to enable or disable the combined mapping alternatives. In such a case the UE 102 is explicitly indicated with the type of the RB mapping. In one embodiment, the mapping type and/or repetition factor for the PUCCH formats can be indicated through the PUCCH resource indicator (PRI) field in the DCI. This could be done by including new column field(s) to the table, where for each of the PUCCH resource, specific mapping type, number of PRBs and/or repetition factor can be signaled.

In some embodiments, another mapping type i.e. mapping type 2 is indicated, then a combination of long sequence/DFT (multiple of 12) is used and that long sequence/DFT is repeated across multiple PRBs. In this case, a number of PRBs, a mapping type, and a repetition factor can be indicated. The number of PRBs indicate the number of PRBs for 1 repetition, alternatively referred to as sequence/DFT length. The mapping type can be 2. The repetition factor indicates the number of times the long sequence/DFT is repeated. Therefore, the total PRB allocation can be determined by multiplication of number of PRBs and the repetition factor. In alternate embodiment, the number of PRBs indicate the total number of PRBs required for transmission of long sequence/DFT across multiple repetitions. In this case, the length of sequence (or alternatively the number of PRBs/repetition) can be determined by dividing the number of PRBs by repetition factor.

In one embodiment, measured reference signal received power (RSRP) from the SSB/CSI-RS could be used for identifying the coverage, thereby resulting in the selection of the mapping type, the number of resource blocs, the repetition factors, the sequence length etc. In the scenarios where the UE is located in the cell edge, the coverage of PUCCH transmission would be the bottle neck for this UE to reach the gNB with sufficient power. Therefore, long sequence option or long DFT is chosen for mapping the PUCCH PRBs, while for the scenarios where large number of UEs are connected to the network, a frequency domain repetition may avoid resource shortage of the cell. However, the scenarios with moderate coverage requirements and moderate multiplexing requirements may benefit from a combination of both options.

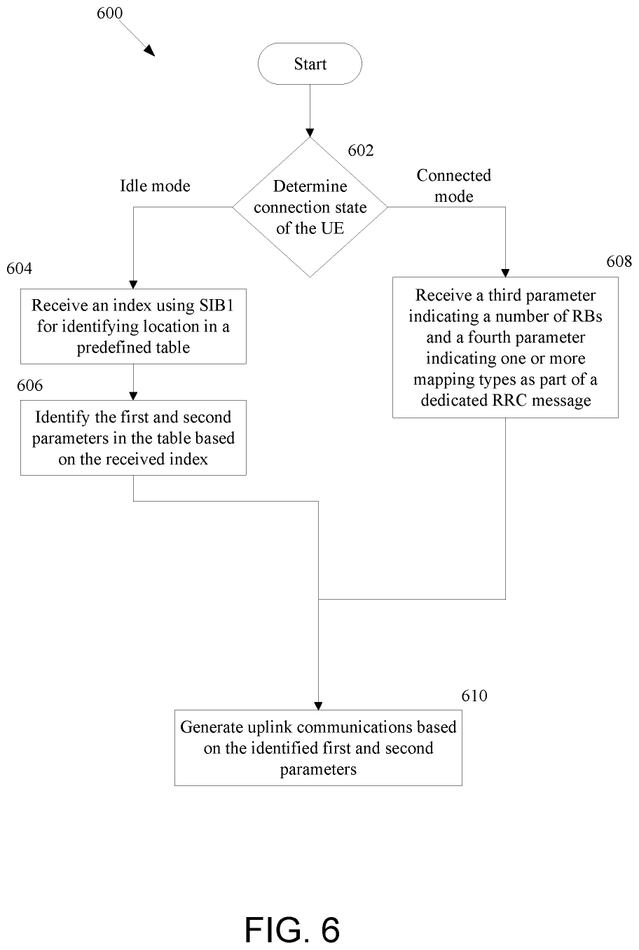

Referring to FIG. 6, a process 600 performed by a UE is provided. At a block 602, a connection state/status of the UE is determined. If at the connection state determination, the UE is determined to be not connected or idle, then at a block 604, an index using SIBI is received. The index identifies a location in a previously defined table associated with PUCCH configuration parameters. At a block 606, a first parameter associated with a number of RBs and a second parameter associated with a mapping type are identified in the table based on the index. If at the connection state determination, the UE is determined to be connected, then at a block 608, a third parameter indicating a number of RBs and a fourth parameter indicating one or more mapping types are received as part of a dedicated RRC message (a dedicated PUCCH resource configuration). At a block 610, as necessary an uplink communication is generated based on the identified first, second, third, or fourth parameters.

In one embodiment, another method performed at a UE includes receiving configuration for the transmission of PUCCH, where-in the configuration includes number of resource blocks, indication of the one or more mapping types. Then, the method receives a PUCCH resource configuration to be used in RRC connected mode and a common PUCCH resource configuration to be used in the RRC idle mode/during initial access. The method then selects one of the PUCCH resource configurations depending on the SCS and a measured RSRP.

In one embodiment, the number of PRBs and the mapping type is pre-defined based on PUCCH resource configuration table for idle mode UEs. The index in the table is indicated to the UE using common PUCCH RRC configuration in SIBI.

In one embodiment, a plurality of RBs parameters in the PUCCH resource configuration corresponding to different SCS.

In one embodiment, the parameter of RBs mapping type in the PUCCH resource configuration table includes three values corresponding to the three values of the number of RBs, where for a large number of RBs long sequence is used while for a low number of RBs, repetition is used.

In one embodiment, two sets of values each for three SCSs are added to the table. Each set represents the number of RBs and the corresponding RB mapping for one UE power class category.

In one embodiment, the number of PRBs and the mapping type is signaled to the UE using RRC dedicated PUCCH resource configuration for RCC connected UEs. Two additional parameters in the RRC PUCCH resource configuration are inserted: nrofPRBs whose value is between 1 and the maximum number of RBs for the configured SCS and mappType whose value is either 0 or 1.

In one embodiment, the UE is indicated to apply a combination of PRB mapping types, where one additional parameter is inserted in the RRC UE-dedicated PUCCH resource configuration message that represents the number of the repetitions to be performed along with the long sequence where the sequence length for PUCCH generation is the ration between the number of the RBs and the number of the repetition.

In one embodiment, the UE is indicated to in the DCI to enable or disable the combination of the PRB mapping, in such a case the UE is explicitly indicated in the DCI with the mapping type to be used for the corresponding PUCCH resource.

Long sequence of length of multiple RBs used and this sequence is repeated multiple times. An example, if the configured #RBs is 15, and number of repetition is 3, then a sequence with length 5 RBs is repeated 3 times in frequency. In Rel16 only IRB is used for PUCCH format0 and 1.

In one embodiment, a method performed at a UE, the method comprises: determining connection status of the UE: in response to determining that the connection status is not connected, selecting one of first parameters indicating a number of RBs and one of second parameters indicating mapping types included in a previously received configuration for the transmission of PUCCH having a predefined table with the first and second parameters: in response to determining that connection status is connected, receiving a dedicated PUCCH resource configuration (RRC message) having a third parameter indicating a number of RBs and a fourth parameter indicating a mapping type: and generating a PUCCH transmission responsive to the selected first and second parameters or the received third and fourth parameters.

In certain embodiments, selecting one of the first parameters and one of the second parameters from the table further comprises: receiving a table index value included in SIBI of the previously received PUCCH configuration: and selecting one of the first parameters and one of the second parameters from the table responsive to the received table index value.

In some embodiments, selecting one of the first parameters and one of the second parameters from the table further comprises: determining SCS associated with synchronization raster previously identified by the UE: and selecting one of the first parameters and one of the second parameters depending on the determined SCS.

In various embodiments, selecting one of the first parameters and one of the second parameters from the table further comprises: receiving measured RSRP within CSI/RS: and selecting one of the first parameters and one of the second parameters depending on the measured RSRP.

In one embodiment, the second parameter includes three values corresponding to different values of the number of RBs: a first sequence is used for a number of RBs being greater than a threshold amount: and a repetition sequence is used for a number of RBs being less than threshold amount.

In certain embodiments, selecting one of the first parameters and one of the

second parameters from the table further comprises: determining a power class category for the UE: and selecting one of the first parameters and one of the second parameters depending on the power class category, wherein the table includes two sets of values each for three different SCSs, each set represents the number of RBs and the corresponding RB mapping for one of the UE power class categories.

In some embodiments, selecting one of the first parameters and one of the second parameters from the table further comprises: selecting the number of the RBs and the mapping type based on an associated power class and a determined SCS.

In various embodiments, the method further comprises: sending in a message 3 (Msg3) the selected first, second, third, or fourth parameters.

In one embodiment, the method further comprises receiving an indication of validity of the selected number of RBs and the mapping type in a message 4 (Msg4) having DCI.

In certain embodiments, the third parameter has a value between 1 and a maximum number of RBs for a determined SCS and the fourth parameter has a value of 0 or 1.

In some embodiments, the method further comprises: applying a combination of mapping types, wherein the dedicated PUCCH resource configuration includes a fifth parameter that represents the number of the repetitions to be performed along with a first sequence, wherein a length of the first sequence for PUCCH generation is a ratio of the number of the RBs and the number of the repetition.

In various embodiments, the method further comprises receiving an indication to enable or disable the combination of the mapping types, in such a case the UE is explicitly indicated in the DCI with the mapping type to be used for the corresponding PUCCH resource.

In one embodiment, an apparatus comprises: a receiver; a transmitter: a processor: and a memory that stores code executable by the processor to: determine connection status of the apparatus: in response to determining that the connection status is not connected, select one of first parameters indicating a number of RBs and one of second parameters indicating mapping types included in a previously received configuration for the transmission of PUCCH having a predefined table with the first and second parameters: in response to determining that connection status is connected, receive a dedicated PUCCH resource configuration (RRC message) having a third parameter indicating a number of RBs and a fourth parameter indicating a mapping type: and generate a PUCCH transmission responsive to the selected first and second parameters or the received third and fourth parameters. In certain embodiments, selecting one of the first parameters and one of the second parameters from the table further comprises: receiving a table index value included in SIBI of the previously received PUCCH configuration: and selecting one of the first parameters and one of the second parameters from the table responsive to the received table index value.

In some embodiments, selecting one of the first parameters and one of the second parameters from the table further comprises: determining sub carrier spacing (SCS) associated with synchronization raster previously identified by the apparatus, a power class category for the apparatus, or a combination thereof: and selecting one of the first parameters and one of the second parameters depending on one of the determined SCS, the determined power class category, or a combination thereof.

In some embodiments, selecting one of the first parameters and one of the second parameters from the table further comprises: receiving measured RSRP within CSI/RS; and selecting one of the first parameters and one of the second parameters depending on the measured RSRP.

In one embodiment, a network unit comprising: a receiver; a transmitter; a processor; and a memory that stores code executable by the processor to: generate an index configured to identify a first parameter indicating a number of RBs and a second parameter indicating mapping types included in a previously determined configuration for the transmission of PUCCH having a predefined table with the first and second parameters; transmit the index to a remote unit determined to in an idle mode; receive a selection of the first and second parameters from the remote unit; perform an acknowledgement of the received selection; and transmit the acknowledgement to the remote unit.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method performed at by a User Equipment user equipment (UE), the method comprising:
determining a connection status of the UE;
in response to determining that the connection status is not connected, selecting one of first parameters indicating a number of resource blocks (RBs) and one of second parameters indicating mapping types included in a previously received configuration for [the] transmission of a physical uplink control channel (PUCCH) having a predefined table with the first and second parameters;
in response to determining that connection status is connected, receiving a dedicated PUCCH resource configuration having a third parameter indicating a number of RBs and a fourth parameter indicating a mapping type; and
generating a physical uplink control channel (PUCCH) transmission responsive to the selected first and second parameters or the received third and fourth parameters.

2. The method of claim 1, wherein selecting one of the first parameters and one of the second parameters from the table further comprises:
receiving a table index value included in system information block 1 (SIB1) of the previously received PUCCH configuration; and
selecting one of the first parameters and one of the second parameters from the table responsive to the received table index value.

3. The method of claim 1, wherein selecting one of the first parameters and one of the second parameters from the table further comprises:
determining sub carrier spacing (SCS) associated with synchronization raster previously identified by the UE; and
selecting one of the first parameters and one of the second parameters depending on the determined SCS.

4. The method of claim 1, wherein selecting one of the first parameters and one of the second parameters from the table further comprises:
receiving measured reference signal received power (RSRP) within channel state information/reference signal (CSI/RS); and
selecting one of the first parameters and one of the second parameters depending on the measured RSRP.

5. The method of claim 1, wherein:
the second parameter includes three values corresponding to different values of the number of RBs;
a first sequence is used for a number of RBs being greater than a threshold amount; and
a repetition sequence is used for a number of RBs being less than threshold amount.

6. The method of claim 1, wherein selecting one of the first parameters and one of the second parameters from the table further comprises:
determining a power class category for the UE; and
selecting one of the first parameters and one of the second parameters depending on the power class category,
wherein the table includes two sets of values each for three different SCSs, each set represents the number of RBs and the corresponding RB mapping for one of the power class categories.

7. The method of claim 1, further comprising:
sending in a message 3 (Msg3) the selected first, second, third, or fourth parameters.
receiving an indication of validity of a selected number of RBs and the mapping type in a message 4 (Msg4) having downlink control information (DCI).

8. The method of claim 1, wherein the third parameter has a value between 1 and a maximum number of RBs for a determined SCS and the fourth parameter has a value of 0 or 1.

9. The method of claim 1, further comprising:
applying a combination of mapping types,
wherein the dedicated PUCCH resource configuration includes a fifth parameter that represents a number of repetitions to be performed along with a first sequence,
wherein a length of the first sequence for PUCCH generation is a ratio of the number of the RBs and the number of the repetitions.

10. The method of claim 1, further comprising receiving an indication to enable or disable the combination of the mapping types, in such a case the UE is explicitly indicated in downlink control information (DCI) with the mapping type to be used for the corresponding PUCCH resource.

11. A user equipment (UE), comprising:
at least one memory; and
at least one processor coupled with the at least one memory and configured to cause the UE to:
determine a connection status of the UE apparatus;
in response to determining that the connection status is not connected, select one of first parameters indicating a number of resource blocks (RBs) and one of second parameters indicating mapping types included in a previously received configuration for transmission of a physical uplink control channel (PUCCH) having a predefined table with the first and second parameters;
in response to determining that connection status is connected, receive a dedicated PUCCH resource configuration having a third parameter indicating a number of RBs and a fourth parameter indicating a mapping type; and
generate a PUCCH transmission responsive to the selected first and second parameters or the received third and fourth parameters.

12. The UE of claim 11, wherein the at least one processor is configured to cause the UE to select one of the first parameters and one of the second parameters from the table by:
receiving a table index value included in system information block 1 (SIB1) of the previously received PUCCH configuration; and
selecting one of the first parameters and one of the second parameters from the table responsive to the received table index value.

13. The UE of claim 11, wherein the at least one processor is configured to cause the UE to select one of the first parameters and one of the second parameters from the table by:
determining sub carrier spacing (SCS) associated with synchronization raster previously identified by the UE, a power class category for the UE, or a combination thereof; and
selecting one of the first parameters and one of the second parameters depending on one of the determined SCS, the determined power class category, or a combination thereof.

14. The UE of claim 11, wherein the at least one processor is configured to cause the UE to select one of the first parameters and one of the second parameters from the table by:
receiving measured reference signal received power (RSRP) within channel state information/reference signal (CSI/RS); and
selecting one of the first parameters and one of the second parameters depending on the measured RSRP.

15. An apparatus for performing a network function, the apparatus comprising:
at least one memory; and
at least one processor coupled with the at least one memory and configured to cause the apparatus to:
generate an index configured to identify a first parameter indicating a number of resource blocks (RBs) and a second parameter indicating mapping types included in a previously determined configuration for physical uplink control channel (PUCCH) transmissions having a predefined table with the first and second parameters;
transmit the index to a remote unit determined to in an idle mode;
receive a selection of the first and second parameters from the remote unit;
perform an acknowledgement of the received selection; and
transmit the acknowledgement to the remote unit.

16. A processor for wireless communication, comprising:
at least one controller coupled with at least one memory and configured to cause the processor to:
determine connection status of the processor;
in response to determining that the connection status is not connected, select one of first parameters indicating a number of resource blocks (RBs) and one of second parameters indicating mapping types included in a previously received configuration for transmission of a physical uplink control channel (PUCCH) having a predefined table with the first and second parameters;
in response to determining that connection status is connected, receive a dedicated PUCCH resource configuration having a third parameter indicating a number of RBs and a fourth parameter indicating a mapping type; and
generate a PUCCH transmission responsive to the selected first and second parameters or the received third and fourth parameters.

17. The processor of claim 16, wherein the at least one controller is configured to cause the processor to select one of the first parameters and one of the second parameters from the table by:
receiving a table index value included in system information block 1 (SIB1) of the previously received PUCCH configuration; and
selecting one of the first parameters and one of the second parameters from the table responsive to the received table index value.

18. The processor of claim 16, wherein the at least one controller is configured to cause the processor to select one of the first parameters and one of the second parameters from the table by:
determining sub carrier spacing (SCS) associated with synchronization raster previously identified by the processor; and
selecting one of the first parameters and one of the second parameters depending on the determined SCS.

19. The processor of claim 16, wherein the at least one controller is configured to cause the processor to select one of the first parameters and one of the second parameters from the table by:
receiving measured reference signal received power (RSRP) within channel state information/reference signal (CSI/RS); and
selecting one of the first parameters and one of the second parameters depending on the measured RSRP.

20. The processor of claim 16, wherein:
the second parameter includes three values corresponding to different values of the number of RBs;
a first sequence is used for a number of RBs being greater than a threshold amount; and
a repetition sequence is used for a number of RBs being less than threshold amount.
